(19) United States
(12) Patent Application Publication
(10) Pub. No.: US 2014/0318384 A1
(43) Pub. Date: Oct. 30, 2014

(54) Cooking Appliance Comprising a Filtration Accessory Capable of Occupying Two Positions

(71) Applicant: SEB S.A., Ecully (FR)

(72) Inventors: Marcel Pinel, Dijon (FR); Guillaume Reiner, Grenoble (FR)

(73) Assignee: SEB S.A., Ecully (FR)

(21) Appl. No.: 14/359,315

(22) PCT Filed: Nov. 20, 2012
(86) PCT No.: PCT/FR2012/052679

§ 371 Date: May 20, 2014

(30) Foreign Application Priority Data
Nov. 22, 2011 (FR) 1160661

(51) Int. Cl. A47J 37/12

(52) U.S. Cl. CPC A47J 37/1219; A47J 37/1257
USPC 99/412

(57) ABSTRACT

Provided is a cooking appliance, notably an electric fat fryer, comprising a housing housing a vat designed to accept a cooking bath, and a removable filtration accessory able to occupy a position in which it is lowered into the vat and a raised position, the filtration accessory comprising bearing members. The bearing members rest on the casing outside the vat when the filtration accessory is in the raised position. The casing has external lateral shapings that receive the bearing members when the filtration accessory is in the lowered position.

The present invention relates to the field of cooking appliances comprising a cooking vat arranged in a casing.

The present invention relates notably, but not exclusively, to electric fat fryers or even pasta cookers.

After having cooked food in a cooking bath, the user may wish to drain the food or simply remove the food residue present in the cooking bath.

Document US 2008 169281 discloses the manufacturing of a cooking appliance comprising a vat arranged in a casing as well as a removable filtration accessory arranged in the vat. The filtration accessory is connected to two gripping members extending from both sides of the vat and is capable of occupying a position in which it is lowered into the vat and a raised position. In order to maintain the filtration accessory in the raised position, however, it is necessary to hook the filtration accessory on a hook mounted inside the vat.

An object of the present invention is to propose a cooking appliance which comprises a filtration accessory capable of occupying a position in which it is lowered into a vat and a raised position, and which is simple in construction.

Another object of the present invention is to propose a cooking appliance which comprises a filtration accessory capable of occupying a position in which it is lowered into a vat and a raised position, and which is easy to use.

These objects are achieved with a cooking appliance, notably an electric fat fryer, comprising a casing housing a vat designed for receiving a cooking bath and a removable filtration accessory capable of occupying a position in which it is lowered into a vat and a raised position, the filtration accessory comprising bearing members, wherein the bearing members rest on the casing outside the vat when the filtration accessory is in the raised position, and wherein the casing comprises external lateral shapings that house the bearing members when the filtration accessory is in the lowered position. These arrangements make it possible to manufacture an appliance in which the vat lacks hooking means. The raised position of the filtration accessory is attainable simply by setting the filtration accessory on the casing.

Advantageously, the external lateral shapings guide the filtration accessory as it is moved from the lowered position to the raised position. This arrangement allows a gradual raising of the filtration accessory, which is in turn conducive to the filtration of the cooking bath.

According to an advantageous embodiment, the filtration accessory comprises two gripping members extending from both sides of the vat when the filtration accessory is in the lowered position. With this arrangement, the filtration accessory can be lifted with both hands, which makes it easier to use a filtration accessory having small openings.

Advantageously then, each gripping member originates from one of the bearing members. With this arrangement, the construction of the appliance can be simplified.

According to an advantageous embodiment, the one or more gripping members protrude in relation to the lateral wall of the casing when the filtration accessory is in the lowered position. With this arrangement, the handling of the filtration accessory is made easier.

The filtration accessory more particularly comprises at least one filtration device extending inside the vat when the filtration accessory is in the lowered position. The filtration device is then immersed in the cooking bath.

Advantageously then, the filtration device extends inside the vat when the filtration accessory is in the raised position. With this arrangement, it is easier to drain the filtration device over the cooking bath.

Advantageously still, the filtration device can be turned inside the vat when the filtration accessory is lifted above the raised position. With this arrangement, the risks of cooking liquid spilling outside the vat can be reduced.

According to an advantageous embodiment, the appliance comprises a removable cooking basket positioned in the vat above the filtration device when the filtration accessory is in the lowered position.

Advantageously still, the filtration device is connected to the bearing members by tabs. With this arrangement, the manufacturing of the vat is made easier.

According to an advantageous embodiment, notably of interest when frying, the appliance comprises a lid designed for closing the vat.

Advantageously then, the lid bears a gasket designed to rest on a top edge of the vat when the lid closes the vat. Notably, cooking steam emissions can be more effectively controlled with this arrangement.

Advantageously still, the vat is round. This arrangement enables a rotation of the filtration device inside the vat while limiting the space between the filtration device and the lateral wall of the vat.

According to an advantageous embodiment, the bearing members and/or the gripping members originate from plastic parts. If desired, the same part can form one of the bearing members and one of the gripping members.

The invention will be better understood by studying an exemplary embodiment, which is no way limiting and which is illustrated in the appended figures. Shown are:

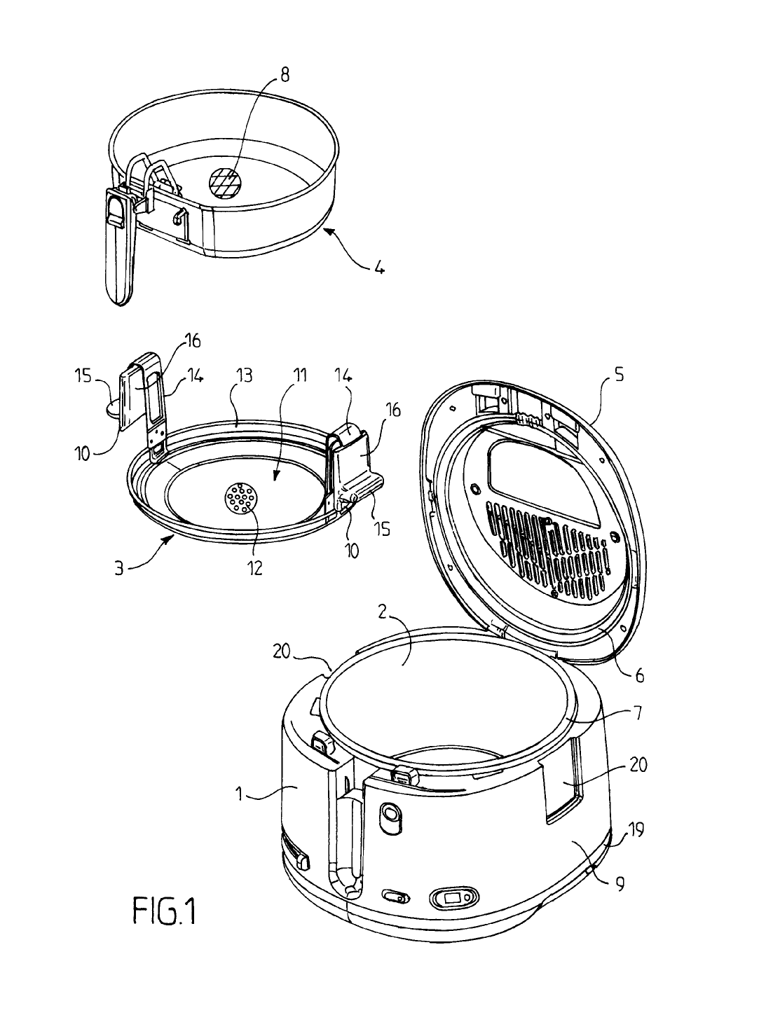

FIG. 1 is a perspective and exploded view of an exemplary embodiment of a cooking appliance according to the invention,

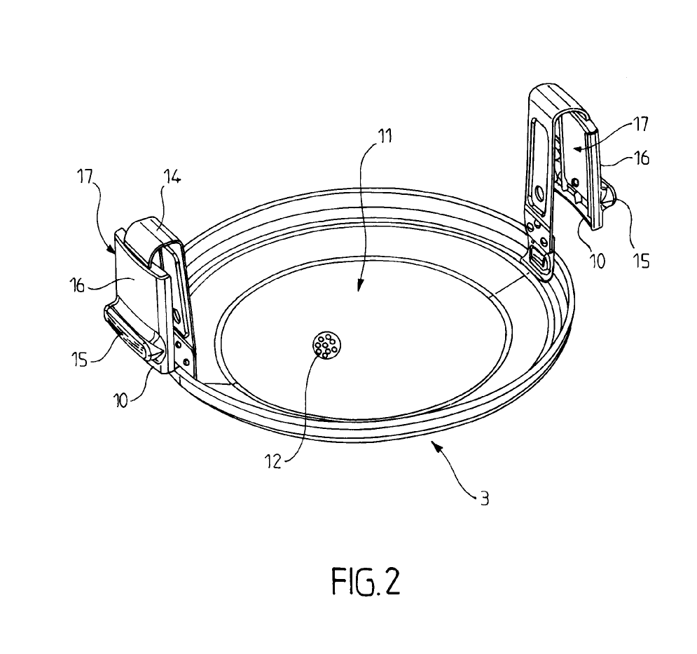

FIG. 2 is a perspective view of a filtration accessory of the appliance illustrated in FIG. 1,

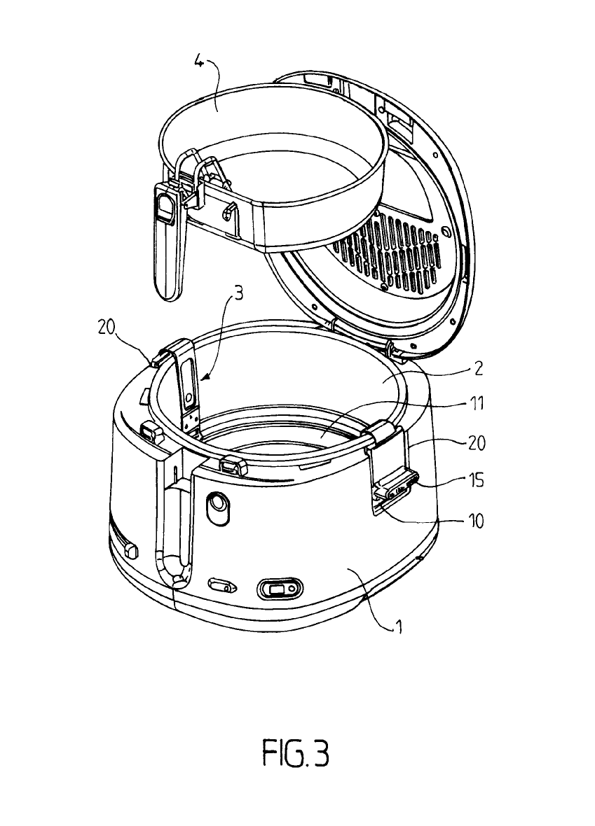

FIG. 3 is a perspective view of the appliance illustrated in FIG. 1, in which the filtration accessory illustrated in FIG. 2 is in a position in which it is lowered into the vat of the appliance,

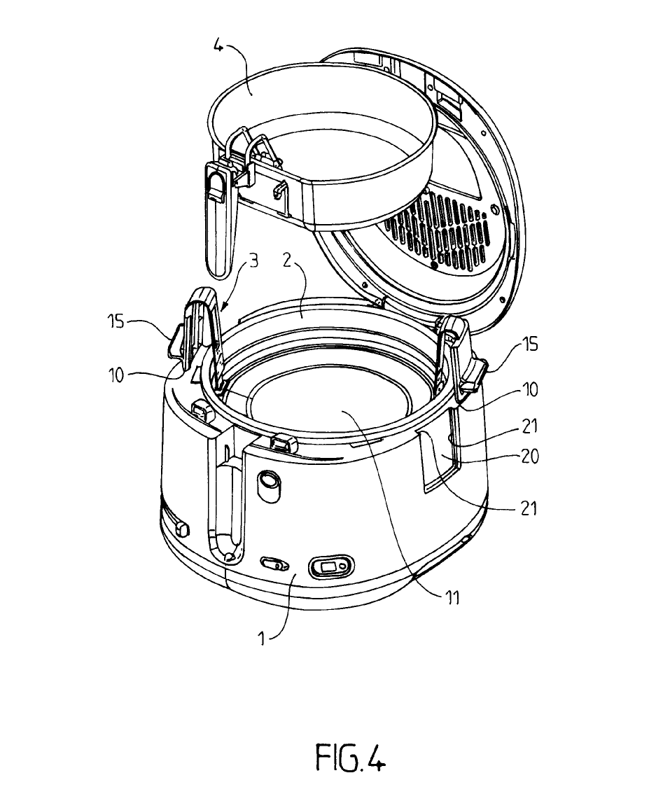

FIG. 4 is a perspective view of the appliance illustrated in FIG. 1, in which the filtration accessory illustrated in FIG. 2 is in a position in which it is raised in the vat of the appliance.

The cooking appliance illustrated in FIG. 1 is an electric fat fryer comprising a casing 1 housing a vat 2 designed for receiving a cooking bath, a removable filtration accessory 3, and also a removable cooking basket 4.

The cooking appliance comprises heating means (not shown in the figures) designed for heating the cooking bath. The heating means can notably comprise an electrical heating element immersed in the cooking bath or an electrical heating element in thermal contact with the vat 2.

The cooking appliance comprises a lid 5 designed for closing the vat 2. The lid 5 is hinge-mounted on the casing 1. The lid 5 bears a gasket 6 designed to rest on a top edge 7 of the vat 2 when the lid 5 closes the vat 2.

The filtration accessory 3 comprises bearing members 10. The bearing members 10 are connected to a filtration device 11. More particularly in the exemplary embodiment illustrated in the figures, the filtration accessory 3 comprises two bearing members 10 arranged opposite the filtration device 11.

The filtration device 11 forms a filtering sieve designed to collect the cooking residues. The filtration device 11 has a bottom 12 surrounded by an upper lateral wall 13. The filtration device 11 is connected to the bearing members 10 by tabs 14.

The filtration accessory 3 comprises gripping members 15. The gripping members 15 are connected to the filtration device 11. More particularly in the exemplary embodiment illustrated in the figures, the gripping members 15 are arranged opposite the filtration device 11. Each gripping member 15 originates from one of the bearing members 10. According to a preferred embodiment, the bearing members 10 and the gripping members 15 originate from plastic parts 16. Notably, the parts 16 can be molded onto the tabs 14.

The filtration device 11 is made, for example, of a perforated sheet material as shown in FIG. 2. The filtration device 11 has filtration openings advantageously less than 2 mm in size, and preferably between 0.8 and 1.5 mm in size.

The filtration device 11 extends beneath the cooking basket 4. The cooking basket 4 has openings 8 that are larger in size than the filtration openings of the filtration device 11.

The cooking residues dropping from the cooking basket 4 can thus be collected in the filtration device 11.

The removable filtration accessory 3 is capable of occupying a position in which it is lowered into the vat 2 and a raised position.

As shown in FIG. 3, the casing 1 comprises external lateral shapings 20 housing the bearing members 10 when the filtration accessory 3 is in the lowered position. The gripping members 15 project in relation to the lateral wall of the casing 1 when the filtration accessory 3 is in the lowered position. The gripping members 15 extend from both sides of the vat 2 when the filtration accessory 3 is in the lowered position.

The filtration device 11 extends inside of the vat 2 when the filtration accessory 3 is in the lowered position.

If desired, the tabs 14 can rest on the top edge 7 of the vat 2. Using tabs 14 to connect the filtration device 11 to the bearing members 10 makes it possible to limit the excess thickness relative to the top edge 7 of the vat 2. With this arrangement, it is easier to achieve a seal between the gasket 6 and the vat 2 when the lid 5 is closed over the casing 1.

As shown in FIG. 4, the bearing members 10 rest on the casing 1 outside the vat 2 when the filtration accessory 3 is in the raised position. The filtration device 11 extends inside the vat 2 when the filtration accessory 3 is in the raised position.

The filtration device 11 can be turned in the vat 2 when the filtration accessory 3 is lifted above the raised position in order to disengage the bearing members 10 from the external lateral shapings 20. The vat 2 is round and the filtration device 11 has a circular configuration, which makes it possible to limit the space between the filtration device 11 and the vat 2 in order to improve the filtration efficiency.

More particularly, the external lateral shapings 20 of the casing 1 have at least one lateral guide member 21 designed to guide a lateral face 17 of the parts 16 when the filtration accessory 3 is lifted to the raised position. The external lateral shapings 20 thus guide the filtration accessory 3 as it is moved from the lowered position to the raised position.

The external lateral shapings 20 of the casing 1 are advantageously formed in a plastic lateral wall 9 of the casing 1. The lateral wall 9 surrounds the vat 2. As shown in FIG. 1, the lateral wall 9 is attached to a bottom 19. The external lateral shapings 20 extend away from the vat 2.

The present invention functions in the following manner.

Prior to cooking food, the user sets the filtration accessory 3 in the position in which it is lowered into the vat 2 by engaging the bearing members 10 in the external lateral shapings 20 of the casing 1. The filtration accessory 3 is at least partially immersed in the cooking bath disposed in the vat 2.

The user can put the food in the cooking basket 4, which is positioned in the vat 2 above the filtration device 11 when the filtration accessory 3 is in the lowered position, in order to cook or fry the food in the cooking bath.

When the cooking is finished, the user removes the cooking basket 4 and can then filter the cooking bath by raising the filtration accessory 3 with the aid of the gripping members 15. The user can turn the filtration accessory 3 after having disengaged the bearing members 10 from the external lateral shapings 20 of the casing 1 and set the bearing members 10 on the casing 1. The filtration device 11 can then drain into the vat 2.

The filtration accessory 3 is thus particularly easy to use and enables the manufacturing of a cooking appliance with a simple construction.

Alternatively, the cooking appliance does not have to comprise a cooking basket separate from the cooking accessory. Notably, the filtration accessory 3 can form a cooking support and/or a cooking basket.

Alternatively, the cooking appliance does not have to be an electric fat fryer. The invention also relates to other cooking appliances that comprise a cooking bath such as pasta cookers. The filtration device 11 is then designed to contain a plate or a serving of pasta.

Alternatively, the filtration accessory 3 can comprise at least one filtration device 11.

Alternatively, the filtration accessory 3 does not have to comprise two opposite gripping members 15. The filtration accessory 3 can comprise at least one gripping member and/or be associated with at least one removable gripping member. If desired, the bearing members 10 and/or the one or more gripping members 15 can originate from plastic parts.

Alternatively, the bearing members 10 and the one or more gripping members 15 can originate from separate parts.

Alternatively, the gripping members 15 do not have to be connected to the filtration device 11. One or a plurality of filtration devices can notably be borne by a support connected to the gripping members. The one or more filtration devices are thus removable in relation to the gripping members.

The present invention is not limited in any way to the exemplary embodiment and its alternatives described herein, but encompasses numerous modifications within the scope of the claims.

1. Cooking appliance, notably an electric fat fryer, comprising a casing housing a vat designed for receiving a cooking bath, and a removable filtration accessory capable of occupying a position in which it is lowered into the vat and a raised position, the filtration accessory comprising bearing members, wherein the bearing members rest on the casing outside the vat when the filtration accessory is in the raised position, and wherein the casing comprises external lateral shapings which house the bearing members when the filtration accessory is in a lowered position.

2. Cooking appliance as in claim 1, wherein the external lateral shapings guide the filtration accessory as it is moved from the lowered position to the raised position.

3. Cooking appliance as in claim 1, wherein the filtration accessory comprises two gripping members extending from both sides of the vat when the filtration accessory is in the lowered position.

4. Cooking appliance as in claim 3, wherein each gripping member originates from one of the bearing members.

5. Cooking appliance as in claim 3, wherein the one or more gripping members project relative to the lateral wall of the casing when the filtration accessory is in the lowered position.

6. Cooking appliance as in claim 1, wherein the filtration accessory comprises at least one filtration device extending inside the vat when the filtration accessory is in the lowered position.

7. Cooking appliance as in claim 6, wherein the filtration device extends inside the vat when the filtration accessory is in the raised position.

8. Cooking appliance as in claim 6, wherein the filtration device can be is rotatable inside the vat when the filtration accessory is lifted above the raised position.

9. Cooking appliance as in claim 6, wherein the cooking appliance comprises a removable cooking basket positioned in the vat above the filtration device when the filtration accessory is in the lowered position.

10. Cooking appliance as in claim 6, wherein the filtration device is connected to the bearing members by tabs.

11. Cooking appliance as in claim 1, including a lid designed for closing the vat.

12. Cooking appliance as in claim 11, wherein the lid carries a gasket for engagement with a top edge of the vat when the lid closes the vat.

13. Cooking appliance as in claim 1, wherein the vat is round.

14. Cooking appliance as in claim 1, wherein the bearing members and/or the gripping members originate from plastic parts.

15. Cooking appliance as in claim 2, wherein the filtration accessory comprises two gripping members extending from both sides of the vat when the filtration accessory is in the lowered position.

16. Cooking appliance as in claim 15, wherein each gripping member originates from one of the bearing members.

17. Cooking appliance as in claim 16, wherein the one or more gripping members project relative to the lateral wall of the casing when the filtration accessory is in the lowered position.
